(19) United States
(12) Patent Application Publication
(10) Pub. No.: US 2015/0309982 A1
(43) Pub. Date: Oct. 29, 2015

(54) GRAMMATICAL ERROR CORRECTING SYSTEM AND GRAMMATICAL ERROR CORRECTING METHOD USING THE SAME

(71) Applicant: POSTECH ACADEMY-INDUSTRY FOUNDATION, Pohang-si Gyeongsangbuk-do (KR)

(72) Inventors: Gary Geunbae LEE, Pohang (KR); Hongsuck SEO, Suwon (KR); Sechun KANG, Gimhae (KR); Jeesoo BANG, Pohang (KR); Kyusong LEE, Seoul (KR)

(21) Appl. No.: 14/443,732

(22) PCT Filed: May 9, 2013
(86) PCT No.: PCT/KR2013/004079

§ 371 Date: May 19, 2015

(30) Foreign Application Priority Data
Dec. 13, 2012 (KR) 10-2012-0145721

(51) Int. Cl. G06F 17/27; G06N 5/04; G06N 99/00

(52) U.S. Cl. CPC G06F 17/274; G06N 99/005; G06N 5/04

(57) ABSTRACT

Provided are a grammatical error correcting system and a grammatical error correcting method using the same, and in detail, the grammatical error correcting system includes: a learning unit configured to acquire a plurality of context features according to a linguistic characteristic from a plurality of corpuses and generate a primary learning classification model and a secondary learning classification model which are references of diagnosing a grammatical error from the context features; and an executing unit configured to predict the grammatical error with respect to a corpus which is input by a learner by using the primary learning classification model, predict the grammatical error by using a primary prediction result of the grammatical error and the secondary learning classification model, and correct the grammatical error, in which the secondary learning classification model is generated by an iterative learning technique by using the plurality of context features extracted from the plurality of corpuses based on the primary prediction result.

### TECHNICAL FIELD

The present invention relates to a grammatical error correcting system and a grammatical error correcting method using the same, and more particularly, to a grammatical error correcting system and a grammatical error correcting method using the same which use a corpus in which a plurality of grammatical errors are written.

### BACKGROUND ART

Generally, a grammatical error correcting system finds an incorrect use of grammar based on a rule constructed by a person or finds a grammatical error by automatically learning the grammar from a corpus. When the grammar is automatically learned and the grammatical error is found from a large capacity corpus, a large capacity native corpus is used or the grammatical error may be learned from a non-native corpus in which the grammatical error is written.

However, there are problems in that it is difficult to accurately detect an error and correct the detected error as compared with a case where various inputs are given due to different characteristics of the corpus only by a method of learning grammar and finding a grammatical error based on the large capacity corpus.

### DISCLOSURE

### Technical Problem

The present invention has been made in an effort to provide a method of learning grammar from a plurality of corpuses having different characteristics, providing a grammatical error correction model for correcting a grammatical error, and accurately finding and correcting the error when an input having various characteristics is given.

### Technical Solution

An exemplary embodiment of the present invention provides a grammatical error correcting system including: a learning unit configured to acquire a plurality of context features according to a linguistic characteristic from a plurality of corpuses and generate a primary learning classification model and a secondary learning classification model which are references of diagnosing a grammatical error from the context features; and an executing unit configured to predict the grammatical error with respect to a corpus which is input by a learner by using the primary learning classification model, predict the grammatical error by using a primary prediction result of the grammatical error ad the secondary learning classification model, and correct the grammatical error.

The secondary learning classification model may be generated by an iterative learning technique by using the plurality of context features extracted from the plurality of corpuses based on the primary prediction result.

The learning unit may include a context feature extracting unit extracting the plurality of context features by receiving the plurality of corpuses, a plurality of basic classification learning units generating one or more primary learning classification models regarding a grammatical error pattern and an error classification as a reference for diagnosing the grammatical error through the iterative learning technique from the plurality of context features, and a plurality of meta classification learning units generating one or more secondary learning classification models through the iterative learning technique by using primary prediction result information which primarily predicts the grammatical error with respect to the corpus input by the learner by using the plurality of context features extracted from the context feature extracting unit and the primary learning classification models.

The secondary learning classification model may include a grammatical error pattern without the primary learning classification model and an error classification.

The grammatical error correcting system may further include a modeling unit configured to store the primary learning classification model and the secondary learning classification model.

The executing unit may include a context feature extracting unit extracting a plurality of context features with respect to the corpus input by the learner, a basic classification predicting unit primarily predicting the grammatical error for the input corpus of the learner by selecting the primary learning classification model corresponding to the extracted context feature to output the primary prediction result, and a meta classification predicting unit predicting the grammatical error for the input corpus of the learner by using the secondary learning classification model and outputting result information thereof when it is determined that the primary prediction result information is not the grammatical error.

The context feature extracting unit may extract the context feature for correcting objective grammar used in a learning process for forming a learning classification model for diagnosing the context error in the learning unit from the input corpus of the learner.

The meta classification predicting unit may not operate when it is determined that the grammatical error exists in the primary prediction result information.

The learning unit may be interlocked with the executing unit to form the secondary learning classification model.

Another exemplary embodiment of the present invention provides a grammatical error correcting method including a learning step of generating a learning model which is a reference for diagnosing a grammatical error from a plurality of corpuses and an executing step of predicting the grammatical error with respect to the corpus input by a learner by using the learning model.

The learning step may include a context feature extracting step of extracting the plurality of context features according to a linguistic characteristic by receiving the plurality of corpuses, a basic classification learning step of generating one or more primary learning classification models regarding a grammatical error pattern and an error classification as a reference for diagnosing the grammatical error through the iterative learning technique from the plurality of context features, and a meta classification learning step of generating one or more secondary learning classification models through the iterative learning technique by using primary prediction result information which primarily predicts the grammatical error with respect to the corpus input by the learner by using the plurality of extracted context features.

The executing step may include a context feature extracting step of extracting a plurality of context features with respect to a corpus input by the learner, a primary prediction step of primarily predicting the grammatical error for the input corpus of the learner by selecting the primary learning classification model corresponding to the extracted context feature among the primary learning classification models generated in the basic classification learning step and outputting a primary prediction result, and a secondary prediction step of predicting the grammatical error for the input corpus of the learner by using the secondary learning classification model and outputting result information thereof when it is determined.

In the context feature extraction step of the executing step, the context feature for correcting objective grammar used in a learning process for forming the learning classification model in the learning step may be extracted from the input corpus of the learner.

The secondary learning classification model may include a grammatical error pattern without the primary learning classification model and an error classification.

### Effects of Invention

According to the exemplary embodiment of the present invention, in order to correct a grammatical error, a correct answer is not selected by learning one classifier, but the correct answer is predicted by using and learning a meta classifier having a plurality of basic classifiers and inputting and integrating a result thereof, and as a result, it is possible to analyze an error and predict an accurate correct answer by accurately determining a grammatical error of input sentences having various characteristics.

Particularly, since the learning is performed according to each basic classifier by using corpuses having different various characteristics in a corpus group with a large size, it is possible to more accurately predict a correct answer with respect to the input sentences having various characteristics.

Further, even though a size of a non-native corpus in which a grammatical error developed in the related art is written is small, it is possible to use a plurality of different corpuses, and as a result, high performance may be expected, thereby efficiently improving an effect of the grammatical error correction.

### BRIEF DESCRIPTION OF THE DRAWINGS

FIG. 1 is a block diagram of a grammatical error correcting system according to an exemplary embodiment of the present invention.

FIG. 2 is a flowchart illustrating a grammatical error correcting method of the present invention according to the grammatical error correcting system of FIG. 1.

### BEST MODE FOR INVENTION

The present invention has been made in an effort to provide a method of learning grammar from a plurality of corpuses having different characteristics, providing a grammatical error correction model for correcting the grammatical error, and accurately finding and correcting the error when an input having various characteristics is given.

To this end, the present invention provides a grammatical error correcting system including: a learning unit configured to acquire a plurality of context features according to a linguistic characteristic from a plurality of corpuses, and generate a primary learning classification model and a secondary learning classification model which are references for diagnosing a grammatical error from the context features; and an executing unit configured to predict the grammatical error with respect to a corpus which is input by a learner by using the primary learning classification model, predict the grammatical error by using a primary prediction result of the grammatical error and the secondary learning classification model, and correct the grammatical error.

Further, the present invention provides a grammatical error correcting method including a learning step of generating a learning model which is a reference for diagnosing a grammatical error from a plurality of corpuses, and an executing step of predicting the grammatical error with respect to the corpus input by a learner by using the learning model.

Technical objects to be achieved in the present invention are not limited to the aforementioned technical objects, and other non-mentioned technical objects will be obviously understood by those skilled in the art from the description below.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Further, in exemplary embodiments, since like reference numerals designate like elements having the same configuration, a first exemplary embodiment is representatively described, and in other exemplary embodiments, only a configuration different from the first exemplary embodiment will be described.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

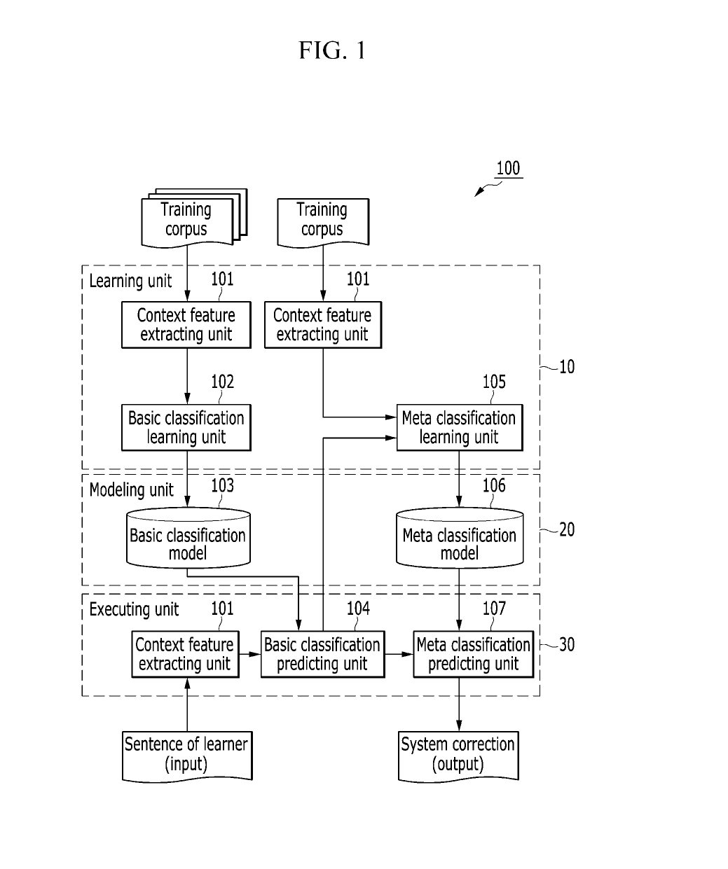

FIG. 1 is a block diagram of a grammatical error correcting system according to an exemplary embodiment of the present invention.

Referring to FIG. 1, a grammatical error correcting system 100 according to the exemplary embodiment of the present invention is configured of a learning unit 10, a modeling unit 20, and an executing unit 30.

The learning unit 10 is configured by a means which extracts and learns linguistic features from a vast amount of training corpuses.

Here, the corpus as basic data for analysis of one language means language information acquired from a plurality of conversations, sentences, or the like of the corresponding language. In addition, the linguistic feature extracted from the corpus means an individual characteristic or feature of the information collected by using a mechanical learning method from a vast amount of corpus data sources. That is, the linguistic feature means a characteristic of a context which may be acquired from the information of the corpus. Hereinafter, the terms linguistic feature, feature, and context feature have the same meaning. In the present invention, the context feature varies according to grammar of the corresponding language as a target to be corrected, and may be selected from the corpus by using the linguistic characteristic. Context features may be selected to be the same as or different from each other for every basic classifier (meaning a basic classification learning unit which is a configuration unit included in the learning unit 10 to be described below) which is used, and are selected by using linguistic knowledge.

In detail, the learning unit 10 includes a context feature extracting unit 101, a basic classification learning unit 102, and a meta classification learning unit 105.

The context feature extracting unit 101 is a means for receiving the plurality of training corpuses to extract the context feature (alternatively, the linguistic feature). The context feature is extracted from the training corpuses in order to predict objective grammar usage in a grammatical error connecting method. That is, the objective grammar is target grammar which needs to be correctly used in a linguistic aspect of the corresponding language, and correcting the grammatical error is to change the grammatical error into the correct target grammar. For example, in English, an objective grammar for using articles, an objective grammar for using prepositions, and the like may be included. Accordingly, the context feature is a characteristic or a feature which is extracted from the corpus so as to generally determine how a learner (a user) expresses the corresponding grammatical characteristic in the context, in order to use correct objective grammar in various grammar characteristic fields.

The basic classification learning unit 102 is a means for primarily forming a learning model by iteratively using a mechanical learning modeling technique from the context feature extracted from the context feature extracting unit 101. Here, the primary learning classification model is a basic classification model regarding basic grammatical error pattern and error classification used for determining whether a grammatical error exists or not in an input sentence. Accordingly, the basic classification learning unit 102 may generate a model of classifying patterns of the grammatical error which may be frequently generated within a predetermined probability range in the plurality of corpuses from the context feature.

The primary learning classification model generated from the basic classification learning unit 102 is transferred to and stored in the modeling unit 20. According to the exemplary embodiment of the present invention, at least one basic classification learning unit 102 is formed according to various characteristics of the context feature, and a plurality of basic learning classification models may be formed through a plurality of basic classification learning units 102.

Further, the learning unit 10 may additionally include the meta classification learning unit 105, and the meta classification learning unit 105, as a means of forming a learning classification model which is a superordinate concept to the basic classification learning unit 102, forms a secondary learning classification model for more accurately checking a grammatical error by collecting the context feature extracted from the context feature extracting unit 101 and result information which primarily predict the grammatical error through the basic classification model.

Here, the secondary learning classification model is called a meta classification model. The meta classification model is a learning classification model acquired by iteratively learning the information of the determined result of the primary grammatical error through the basic classification model and the context feature information so as to detect a complex grammatical error which may not be determined or a grammatical error which is hardly determined even by using the basic classification model.

Similarly, the secondary learning classification model generated from the meta classification learning unit 105 is transferred to and stored in the modeling unit 20. According to the exemplary embodiment of the present invention, since the meta classification learning unit 105 integrally generates a classification model through a learning process by using the information of the determined result of the grammatical error primarily predicted through the plurality of basic learning classification models, a plurality of meta classification learning units may be set according to various characteristics of the context feature. Since the meta classification learning unit 105 is a means of collecting and learning the primarily determined result of the basic learning classification model generated from the plurality of basic classification learning units 102, the number of constituent elements may be formed to be smaller than the number of constituent elements of the basic classification learning units 102.

The input of the meta classification learning unit 105 is different from the input of the basic classification learning unit 102. That is, there is a difference in that, as the context feature extracted from the corpus, the context feature extracted from sentences which are mainly used by common people is input to an input terminal of the basic classification learning unit 102, while the context feature extracted from the primarily determined result generated in the basic classification learning unit 102 is input to an input terminal of the meta classification learning unit 105.

Meanwhile, the modeling unit 20 is a means for storing a predetermined mechanical learning model formed from each learning process output obtained by repeating a learning process from the context feature acquired from the corpus in the learning unit 10. As described above, the modeling unit 20 may be divided into a basic classification model (basic learning classification model) 103 for forming at least a plurality of basic and lower learning models, and a meta classification model (meta learning classification model) 106 for forming an upper learning model by again using the learning modeling technique from the basic classification model.

Meanwhile, in the grammatical error correcting system 100, the executing unit 30 is a means for actually detecting the grammatical error from the sentence which is directly input by the user (alternatively, the learner) and correcting the detected grammatical error.

Referring to FIG. 1, the executing unit 30 includes a context feature extracting unit 101, a basic classification predicting unit 104, and a meta classification predicting unit 107.

The context feature extracting unit 101 as the same means as the means configured in the learning unit 10 extracts the context feature from the corpus. The context feature extracting unit 101 included in the executing unit 30 may extract the context feature individually or grouped in a predetermined unit from the plurality of sentences which are particularly input by the user.

The result information of the context feature according to various characteristics extracted from the context feature extracting unit 101 is transferred to the basic classification predicting unit 104, and the basic classification predicting unit 104 predicts and determines the primary grammatical error by using at least one basic learning classification model acquired by the modeling unit 20. That is, the basic classification predicting unit 104 selects at least one basic learning classification model related to a characteristic corresponding to the context feature extracted from the input sentence of the user among the plurality of basic learning classification models stored in the modeling unit 20, and primarily determines the grammatical error with respect to the context feature extracted from the input sentence by using the selected basic learning classification model.

When the basic classification predicting unit 104 determines that the grammatical error exists, the grammatical error system of the present invention immediately determines the grammatical error without execution of the meta classification predicting unit 107 included in the executing unit 30, and corrects and outputs the corresponding grammatical error part. In the exemplary embodiment of FIG. 1 of the present invention, for convenience of description, the correcting means of the grammatical error part is not illustrated, but the grammatical error of the part predicted in the input sentence may be corrected by using known technique and means.

On the other hand, even though the basic classification predicting unit 104 is primarily predicted, when it is determined that no grammatical error exists, the corresponding primary result information is transferred to the learning unit 10 as described above to be used for forming the secondary learning model (meta learning model).

Further, the input sentence having the primary grammatical error predicted result is transferred to the meta classification predicting unit 107. Then, the meta classification predicting unit 107 determines the grammatical error by using the secondary learning classification model (meta classification model) 106 stored in the modeling unit 20 in order to accurately extract a complicated and difficult grammatical error which is not derived by using the basic learning classification model.

The meta classification predicting unit 107 may find the complicated and difficult grammatical error which is not yet determined through the primary prediction process in the sentence input by the user (the learner) by using the meta classification model learned by again using the context feature information and the primary determined result information after the basic classification modeling process. When it is determined that the grammatical error exists by finally determining the sentence of the user by using the meta classification model, the meta classification predicting unit 107 corrects the corresponding grammatical error, and when it is determined that no grammatical error exits, the meta classification predicting unit 107 outputs the sentence as it is to finally determine the use of the objective grammar.

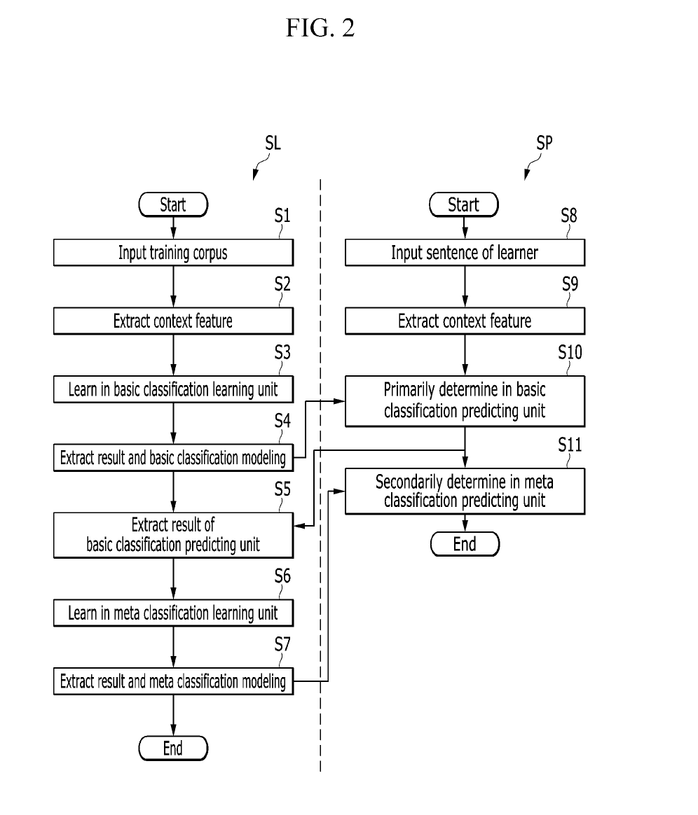

FIG. 2 is a flowchart illustrating a grammatical error correcting method of the present invention according to the grammatical error correcting system of FIG. 1.

As illustrated in FIG. 2, a grammatical error correcting method according to the exemplary embodiment of the present invention is configured by a learning step SL and an execution step SP.

The learning step SL is a process of extracting a context feature by using a training corpus and generating a learning classification model through each predetermined learning process from the extracted context feature.

Meanwhile, the execution step SP is a process of determining a grammatical error by using a sentence which is actually input by a learner and correcting the determined grammatical error.

In the learning step SL, first, a plurality of training corpuses are input (S1). A plurality of context features are extracted from the training corpuses according to a linguistic characteristic (S2).

In step S2, the extracted context features may be classified for each characteristic, and the basic classification learning unit 102 performs a repeated learning process (S3). The basic classification learning unit performs the repeated learning process by receiving context feature information extracted from the training corpus as an input to extract a result (S4). Since the results may be formed as a predetermined model when the learning process is iteratively performed, the basic classification learning unit may extract the result and simultaneously perform primarily basic classification modeling as the corresponding result (S4).

Next, the prediction of the primary grammatical error for the input sentence of the user is performed by using the basic classification modeling generated in step S4. That is, the basic classification predicting unit 104 extracts a primary grammar prediction result (S5).

In step S5, when it is determined that the grammatical error exists, the grammatical error is immediately output through the correction process (not illustrated), and when it is not determined that the grammatical error exists, the repeated learning process is performed in the meta classification learning unit 105 (S6). As described in FIG. 1, the process of S6 is to perform an upper-concept modeling through the repeated learning again by using the context feature based on the primary basic classification prediction result information.

Then, the result is extracted, and the meta classification learning unit 105 forms a meta classification model which is the secondary learning classification model (S7). As a result, the learning step SL according to the exemplary embodiment of the present invention ends.

The grammatical error correcting method includes the learning step SL and the execution step SP in which the grammatical error of the actually input sentence is corrected for modeling extracted based on the learning step SL.

In detail, in the execution step SP, first, the learner (the user) inputs a plurality of sentences (S8).

Then, in the context feature extracting unit, the context feature is extracted from the plurality of input sentences (S9). In this case, the extraction of the context feature is to extract the context feature for correcting objective grammar which has been used in the learning process for forming the modeling. That is, when each of the plurality of sentences is learned in each basic classification learning unit, all of the used context features are extracted.

The extracting of the context feature in the input sentence is to acquire the context information, and accuracy of the grammar of the input sentence may be predicted by using the basic classification model formed in step S4 based on the context information. That is, the basic classification predicting unit 104 determines primary grammar accuracy with respect to the input sentence of the learner (S10).

In this case, as described in step S5 of the learning step SL, the grammatical error information result which is primarily determined in the basic classification predicting unit is transferred for the meta classification modeling. That is, the grammatical error correcting system according to the exemplary embodiment of the present invention is to implement the modeling for more accurately determining the grammatical error by interlocking and using the learning unit and the executing unit.

In step S10, when it is determined that no grammatical error exists, the grammatical accuracy is finally predicted again by using the meta classification model formed in step S7 with respect to the context feature information of the input sentence (S11). That is, the meta classification predicting unit predicts the grammatical use by using the meta classification model which is the upper learning classification model by interlocking with the result output from the basic classification predicting unit.

When the predicted result is the same as the input of the learner, it is classified that no grammatical error exists, and when the predicted result is different from the input of the learner, it is classified that a grammatical error exists. Finally, when it is determined that the grammatical error exists, the grammatical error system outputs information for notifying the user of the grammatical error. However, the grammatical error system is not limited thereto, and the grammatical error system may correct the corresponding grammatical error part by using the known correcting means and output the corrected result.

The drawings referred to above and the disclosed description of the present invention only illustrate the present invention, and are intended to describe the present invention, not to restrict the meanings or the scope of the present invention claimed in the claims. Therefore, those skilled in the art can easily select and substitute the drawings and disclosed description. In addition, those skilled in the art can omit some of the constituent elements described in the present specification without deterioration in performance thereof, or can add constituent elements to improve performance thereof. Furthermore, those skilled in the art can modify the sequence of the steps of the method described in the present specification depending on the process environment or equipment. Therefore, the scope of the present invention must be determined by the scope of the claims and the equivalents, not by the described embodiments.

### INDUSTRIAL APPLICABILITY

The present invention provides a method of learning grammar from a plurality of corpuses having different characteristics, providing a grammatical error correction model for correcting a grammatical error, and accurately finding and correcting an error when an input having various characteristics is given.

1. A grammatical error correcting system, comprising:
a learning unit configured to acquire a plurality of context features according to a linguistic characteristic from a plurality of corpuses and generate a primary learning classification model and a secondary learning classification model which are references for diagnosing a grammatical error from the context features; and
an executing unit configured to predict the grammatical error with respect to a corpus which is input by a learner by using the primary learning classification model, predict the grammatical error by using a primary prediction result of the grammatical error and the secondary learning classification model, and correct the grammatical error,
wherein the secondary learning classification model is generated by an iterative learning technique by using the plurality of context features extracted from the plurality of corpuses based on the primary prediction result.

2. The grammatical error correcting system of claim 1, wherein
the learning unit includes:
a context feature extracting unit extracting the plurality of context features by receiving the plurality of corpuses;
a plurality of basic classification learning units generating one or more primary learning classification models regarding a grammatical error pattern and an error classification as a reference for diagnosing the grammatical error through the iterative learning technique from the plurality of context features; and
a plurality of meta classification learning units generating one or more secondary learning classification models through the iterative learning technique by using primary prediction result information which primarily predicts the grammatical error with respect to the corpus input by the learner by using the plurality of context features extracted from the context feature extracting unit and the primary learning classification models.

3. The grammatical error correcting system of claim 2, wherein
the secondary learning classification model includes a grammatical error pattern without the primary learning classification model and an error classification.

4. The grammatical error correcting system of claim 1, further comprising
a modeling unit configured to store the primary learning classification model and the secondary learning classification model.

5. The grammatical error correcting system of claim 1, wherein
the executing unit includes:
a context feature extracting unit extracting a plurality of context features with respect to the corpus input by the learner;
a basic classification predicting unit primarily predicting the grammatical error for the input corpus of the learner by selecting the primary learning classification model corresponding to the extracted context feature to output the primary prediction result; and
a meta classification predicting unit predicting the grammatical error for the input corpus of the learner by using the secondary learning classification model and outputting result information thereof when it is determined that the primary prediction result information is not the grammatical error.

6. The grammatical error correcting system of claim 5, wherein
the context feature extracting unit extracts the context feature for correcting objective grammar used in a learning process for forming a learning classification model for diagnosing the context error in the learning unit from the input corpus of the learner.

7. The grammatical error correcting system of claim 5, wherein
the meta classification predicting unit does not operate when it is determined that the grammatical errorDeletedTextsexists in theDeletedTextsprimary prediction result information.

8. The grammatical error correcting system of claim 1, wherein
the learning unit is interlocked with the executing unit to form the secondary learning classification model.

9. A grammatical error correcting method, comprising
a learning step of generating a learning model which is a reference for diagnosing a grammatical error from a plurality of corpuses and an executing step of predicting the grammatical error with respect to the corpus input by a learner by using the learning model,
wherein the learning step comprises:
a context feature extracting step of extracting the plurality of context features according to a linguistic characteristic by receiving the plurality of corpuses;
a basic classification learning step of generating one or more primary learning classification models regarding a grammatical error pattern and an error classification as a reference for diagnosing the grammatical error through the iterative learning technique from the plurality of context features; and
a meta classification learning step of generating one or more secondary learning classification models through the iterative learning technique by using primary prediction result information which primarily predicts the grammatical error with respect to the corpus input by the learner by using the plurality of extracted context features, and
the executing step comprises:
a context feature extracting step of extracting a plurality of context features with respect to a corpus input by the learner;
a primary prediction step of primarily predicting the grammatical error for the input corpus of the learner by selecting the primary learning classification model corresponding to the extracted context feature among the primary learning classification models generated in the basic classification learning step and outputting a primary prediction result; and
a secondary prediction step of predicting the grammatical error for the input corpus of the learner by using the secondary learning classification model and outputting result information thereof when it is determined that the primary prediction result information is not the grammatical error.

10. The grammatical error correcting method of claim 9, wherein,
in the context feature extraction step of the executing step,
the context feature for correcting objective grammar used in a learning process for forming the learning classification model in the learning step is extracted from the input corpus of the learner.

11. The grammatical error correcting method of claim 9, wherein
the secondary learning classification model includes a grammatical error pattern without the primary learning classification model and an error classification.
